(19) United States
(12) Patent Application Publication
(10) Pub. No.: US 2026/0008250 A1
(43) Pub. Date: Jan. 8, 2026

(54) COMPOSITE MATERIALS WITH MEMBRANE

(71) Applicant: The North Face Apparel Corp., Wilmington, DE (US)

(72) Inventors: Cory Michael Olson, Golden, CO (US); Vijanderan Somasundaram, Dublin, CA (US)

(21) Appl. No.: 18/933,002

(22) Filed: Oct. 31, 2024

Related U.S. Application Data
(63) Continuation of application No. 17/642,490, filed on Mar. 11, 2022, now Pat. No. 12,162,261.
(60) Provisional application No. 62/900,001, filed on Sep. 13, 2019.

(51) Int. Cl. B32B 5/26; A41D 1/00; A41D 1/02; A41D 1/04; A41D 1/06; A41D 19/00; A41D 31/102; A41D 31/14; A41D 31/18; A42B 1/00; A43B 7/12; A43B 23/02; A47G 9/08; B32B 5/02; B32B 5/04; B32B 5/08; B32B 7/12; B32B 7/14; B32B 27/02; B32B 27/12; B32B 27/34; B32B 27/36; B32B 27/40; E04H 15/54

(52) U.S. Cl. CPC B32B 5/26; A41D 1/02; A41D 19/0006; A41D 31/102; A41D 31/14; A43B 7/125; B32B 5/02; B32B 5/08; B32B 7/12; B32B 27/36; A41D 1/00; A41D 1/04; A41D 1/06; A41D 31/145; A41D 31/18; A41D 2500/10; A41D 2500/20; A41D 2500/30; A42B 1/00; A43B 23/022; A43B 23/026; A47G 9/086; B32B 5/022; B32B 5/024; B32B 5/026; B32B 5/04; B32B 5/262; B32B 5/265; B32B 5/275; B32B 5/279; B32B 7/14; B32B 27/02; B32B 27/12; B32B 27/34; B32B 27/40; B32B 2250/02; B32B 2250/24; B32B 2262/0261; B32B 2262/0276; B32B 2262/0292; B32B 2262/14; B32B 2262/148; B32B 2262/152; B32B 2307/51; B32B 2307/554; B32B 2307/712; B32B 2307/718; B32B 2307/724; B32B 2307/7265; B32B 2437/00; B32B 2437/02; B32B 2437/04; D10B 2501/04; D10B 2501/041; D10B 2501/043; D10B 2505/18; E04H 15/54; Y10T 428/24851; Y10T 428/27; Y10T 442/3008; Y10T 442/3016; Y10T 442/3024; Y10T 442/3707; Y10T 442/413; Y10T 442/494

(57) ABSTRACT

Composite materials are described herein. An example composite material may comprise a shell fiber layer. The example composite material may comprise a membrane disposed adjacent the shell fiber layer.

### CROSS-REFERENCE TO RELATED APPLICATIONS

This application is a Continuation of U.S. application Ser. No. 17/642,490, filed Mar. 11, 2022, which is a National Phase filing of International Patent Application Serial No. PCT/US2020/050367, filed Sep. 11, 2020, which claims the benefit of and priority to U.S. Provisional Application No. 62/900,001 filed Sep. 13, 2019, each of which are hereby incorporated by reference in its entirety for any and all purposes.

### BACKGROUND

Some items, such as snow pants, footwear, tents, etc., may be useful for keeping users comfortable. Keeping users comfortable may comprise keeping users dry from rain, hail, snow, etc. Making items out of material that is sufficiently water-resistant may keep users dry. Keeping users comfortable may comprise allowing hot air to escape so that users may remain cool. Making items out of material that is sufficiently breathable may allow hot air to escape. Improvements are needed.

### SUMMARY

Composite materials are described herein. An example composite material may comprise a shell fiber layer. The example composite material may comprise a membrane disposed adjacent the shell fiber layer. The example composite material may exhibit a low range hydrostatic water resistance of above 5000 millimeter (mm) as measured using American Association of Textile Chemists and Colorists (AATCC) 127. The example composite material may exhibit an air permeability of above 0.25 cubic feet per minute (cfm) as measured using American Society for Testing and Materials (ASTM) D737. The example composite material may exhibit a moisture vapor transmission rate (MVTR) of above 30 kilogram per square meter per 24 hour (kg/sqm/24 hr) as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeter (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilogram per square meter per 24 hour (kg/sqm/24 hr) and 60 Kg/sqm/24 hr as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeter (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilogram per square meter per 24 hour (kg/sqm/24 hr) and 55 Kg/sqm/24 hr as measured using Japanese Industry Standards (JIS) L1099-B1.

Composite materials are described herein. An example composite material may comprise a shell fiber layer. The example composite material may comprise a membrane disposed adjacent the shell fiber layer. The example composite material may exhibit a low range hydrostatic water resistance of between 5000 millimeter (mm) and 25,000 mm as measured using American Association of Textile Chemists and Colorists (AATCC) 127. The example composite material may exhibit an air permeability of between 0.75 and 1 cubic feet per minute (cfm) as measured using American Society for Testing and Materials (ASTM) D737.

Articles are described herein. An example article may comprise composite material described herein. The example article may comprise a garment, gloves, footwear, headwear, bib pants, pants, a jacket, a tent, a sleeping bag, and a backpack. Other articles may be used.

### DETAILED DESCRIPTION

Composite materials are described herein. The composite materials may be or comprise laminate materials having a plurality of layers. An example composite material may comprise a shell and a membrane. The shell may comprise a shell fiber layer. The shell may comprise various materials such as polymers. The shell may comprise polyester, nylon, recycled polyester, elastane, or combinations thereof. Other materials may be used. The membrane may be or comprise a breathable membrane. The membrane may be or comprise a water proof or water repellant membrane. The membrane may be formed from various process such as fiber spinning (e.g., electrospinning). Together, the shell and membrane may have a fabric weight. Various combinations of shell and membrane weight may be used. The membrane may have a weight of less than 9 gsm, less than 8 gsm, less than 7 gsm, less than 6 gsm, less than 5 gsm, less than 4 gsm, or less than 3 gsm. Other weight membranes may be used. The shell and the membrane may be disposed adjacent each other and may be coupled together, for example using adhesive.

The composites of the present disclosure show improved performance over comparative conventional materials. As shown more clearly in Tables 1-3, the composite materials of the present disclosure are identified using ID's: LV6W, LV6Z, LV74, LWEN, LV71, LWEQ, LV75, LWEP, LV7B, LV7D, and LWEO. The comparative examples are identified as A-L. The Appendix, which is hereby incorporate herein by reference in its entirety shows improved performance of the composite materials after 20 launderings.

Table 1 matches “High”, “Medium”, and “Low” labels for example value ranges for various measurements:

| | Low Range | | Air | | | |
|---|---|---|---|---|---|---|
| | Hydrostatic | | Permeability | | | |
| | (AATCC 127) - | | (ASTM D737) - | | MVTR (JIS | |
| KEY | As Received | | As Received | | L1099-B1) | |
| High | 10,000 | mm+ | .75 | cfm+ | 45K | g/sqm/24 hr+ |
| Medium | 5,000-10,000 | mm | .25-.75 | cfm | 30K-45K | |
| | | | | | g/sqm/24 hr | |
| Low | 0-5,000 | mm | 0-0.25 | cfm | 0-30K | g/sqm/24 hr |

Table 2 shows attributes of various jackets:

| | Shell Fiber | Fabric | |
|---|---|---|---|
| ID | Content | Weight | |
| A | 72% | 132 | gsm |
| | Polyester, | | |
| | 28% Nylon | | |
| B | 100% Nylon | 82 | gsm |
| C | 100% Nylon | 182 | gsm |
| D | 100% Nylon | 84 | gsm |
| | with 100% | | |
| | Polyester | | |
| | Backer | | |
| E | 100% Nylon | 83 | gsm |
| F | 100% | Body: | |
| | Recycled | 150 | |
| | Polyester | gsm; | |
| | | Hood; | |
| | | 153 gsm | |
| G | 100% Nylon | Body: | |
| | | 105 | |
| | | gsm; | |
| | | Hood: | |
| | | 115 gsm | |
| H | 100% Nylon | 161 | gsm |
| I | 100% Nylon | 120 | gsm |
| J | 100% Nylon | 54 | gsm |
| K | 100% Nylon | 64 | gsm |
| L | 100% | 114 | gsm |
| | Recycled | | |
| | Polyester | | |
| LV6W | 58% Nylon, | 102 | gsm |
| | 37% | | |
| | Polyester, | | |
| | 5% Elastane | | |
| LV6Z | 100% | 177 | gsm |
| | Polyester | | |
| LV74 | 100% | 173 | gsm |
| | Polyester | | |
| LWEN | 93% Nylon, | 160 | gsm |
| | 7% Elastane | | |
| LV71 | 100% | 91 | gsm |
| | Polyester | | |
| LWEQ | 93% Nylon, | 168 | gsm |
| | 7% Elastane | | |
| LV75 | 62% Nylon, | 136 | gsm |
| | 33% | | |
| | Polyester, | | |
| | 5% Elastane | | |
| LWEP | 93% Nylon, | 158 | gsm |
| | 7% Elastane | | |
| LV7B | 75% | 163 | gsm |
| | Polyester, | | |
| | 25% Nylon | | |
| LV7D | 75% | 165 | gsm |
| | Polyester, | | |
| | 25% Nylon | | |
| LWEO | 96% Nylon, | 164 | gsm |
| | 4% Elastane | | |

Table 3 shows attributes of various articles:

| ID | Shell Fiber Content | Fabric Weight |
|---|---|---|
| LMTU | 100% Polyester | 118 |
| LNWU | 82% Nylon, 14% Polyester, 4% Elastane | 230 |
| LUS0 | 100% Polyester | 62 |
| LV6W | 58% Nylon, 37% Polyester, 5% Elastane | 102 |
| LV71 | 100% Polyester | 91 |
| LVAZ | 91% Polyester, 9% Elastane | 207 |
| LVB0 | 93% Polyester, 7% Elastane | 237 |
| LVB1 | 100% Nylon | 53 |
| LVRX | 100% Nylon | 83 |
| LWEN | 93% Nylon, 7% Elastane | 160 |
| LWEO | 96% Nylon, 4% Elastane | 164 |
| LWEP | 93% Nylon, 7% Elastane | 158 |
| LWEQ | 93% Polyester, 7% Elastane | 168 |
| LWQY | 77% Polyester, 23% Nylon | 124 |
| LWQZ | 72% Nylon, 28% Polyester | 115 |
| LYMC | 100% Nylon | 218 |
| LYMD | 100% Nylon | 177 |
| LYMG | 69% Polyester, 31% Nylon | 102 |
| LYMP | 100% Nylon | 99 |
| LYON | 100% Polyester | 112 |
| LZ6I | 100% Nylon | 108 |
| LMTU | 100% Polyester | 118 |
| LUS0 | 100% Polyester | 62 |
| LV6W | 58% Nylon, 37% Polyester, 5% Elastane | 102 |
| LV6Z | 100% Polyester | 177 |
| LV71 | 100% Polyester | 91 |
| LV73 | 100% Polyester | 100 |
| LV74 | 100% Polyester | 173 |
| LV92 | 100% Polyester | 155 |
| LVAZ | 91% Polyester, 9% Elastane | 207 |
| LVB0 | 93% Polyester, 7% Elastane | 237 |
| LVB1 | 100% Nylon | 53 |
| LVRX | 100% Nylon | 83 |
| LVZ2 | 64% Polyester, 27% Wool, 9% Nylon | 332 |
| LWEN | 93% Nylon, 7% Elastane | 160 |
| LWEO | 96% Nylon, 4% Elastane | 164 |
| LWEP | 93% Nylon, 7% Elastane | 158 |
| LWEQ | 93% Polyester, 7% Elastane | 168 |
| LWQY | 77% Polyester, 23% Nylon | 124 |
| LWQZ | 72% Nylon, 28% Polyester | 115 |
| LXO2 | 100% Polyester | 160 |
| LXVP | 100% Polyester | 186 |
| LXVX | 100% Nylon | 246 |
| LY15 | 100% Polyester | 108 |
| LYMC | 100% Nylon | 218 |
| LYMD | 100% Nylon | 177 |
| LYOM | 100% Nylon | 153 |
| LYON | 100% Polyester | 112 |
| LYOP | 89% Polyester, 11% Elastane | 157 |
| LYOQ | 100% Polyester | 198 |
| LYOR | 51% Polyester, 49% Nylon | 140 |
| LYOT | 100% Polyester | 110 |
| LYOU | 100% Nylon | 135 |
| LYOV | 100% Nylon | 95 |
| LYOV | 100% Nylon | 95 |
| LYOW | 100% Nylon | 154 |
| LZIM | 91% Polyester, 9% Elastane | 178 |
| M1T5 | 97% Polyester, 3% Elastane | 218 |
| LV6Z | 100% Polyester | 177 |
| LVRX | 100% Nylon | 83 |
| LYMC | 100% Nylon | 218 |
| LYON | 100% Polyester | 112 |
| LZ6I | 100% Nylon | 108 |
| LV92 | 100% Polyester | 155 |
| LWQY | 77% Polyester, 23% Nylon | 124 |
| LWQZ | 72% Nylon, 28% Polyester | 115 |
| M4IP | 100% Polyester | 98 |
| M4RW | 79% Polyester, 21% Nylon | 158 |
| LYMC | 100% Nylon | 218 |
| LYON | 100% Polyester | 112 |
| LYOU | 100% Nylon | 135 |
| LYOW | 100% Nylon | 154 |
| M1T5 | 97% Polyester, 3% Elastane | 218 |
| M4IM | 100% Nylon | 106 |
| M4RX | 100% Polyester | 116 |
| M4SY | 100% Nylon | 254 |
| M4TF | 63% Polyester, 29% Nylon, 8% Polyethylene | 136 |
| M4TG | 72% Polyester, 21% Nylon, 7% Polyethylene | 142 |
| M4TI | 75% Polyester, 25% Nylon | 121 |
| M4TJ | 100% Polyester | 177 |
| M4WO | 100% Polyester | 161 |
| M52J | 94% Polyester, 6% Polyethylene | 175 |
| M59R | 68% Polyester, 32% Nylon | 94 |
| M5KD | 100% Polyester | 163 |
| M5LR | 100% Polyester | 110 |
| M6AO | 100% Polyester | 128 |
| M6JU | 90% Nylon, 10% Polyethylene | 74 |
| M6JW | 72% Polyester, 21% Nylon, 7% Polyethylene | 142 |

Table 4 matches labels shows in Table 1 with jackets identified in Table 2.

| | Low Range | Air | |
|---|---|---|---|
| | Hydrostatic (AATCC | Permeability (ASTM | MVTR (JIS |
| ID | 127) - As Received | D737) - As Received | L1099-B1) |
| A | High | Medium | Low |
| B | Low | Medium | High |
| C | High | Low | Low |
| D | Low | High | Medium |
| E | Medium | Low | Low |
| F | High | Low | Medium |
| G | High | Low | High |
| H | High | Low | Low |
| I | High | Low | Medium |
| J | Medium | Low | Medium |
| K | Low | Low | Low |
| L | High | Low | Low |
| LV6W | Medium | Medium | Medium |
| LV6Z | High | Medium | Medium |
| LV74 | High | Medium | Medium |
| LWEN | Medium | Medium | Low |
| LV71 | Medium | High | High |
| LWEQ | Medium | Medium | Medium |
| LV75 | Medium | Medium | Medium |
| LWEP | Medium | Medium | Low |
| LV7B | High | Medium | Medium |
| LV7D | Medium | Medium | Medium |
| LWEO | Medium | High | Low |

Table 5 matches labels shows in Table 1 with articles identified in Table 3.

| | Low Range | | |
|---|---|---|---|
| | Hydrostatic (AATCC | Air Permeability (ASTM | MVTR (JIS |
| ID | 127) - As Received | D737) - As Received | L1099-B1) |
| LMTU | High | Medium | Medium |
| LNWU | High | Medium | Low |
| LUS0 | Low | Medium | High |
| LV6W | Medium | Medium | Medium |
| LV71 | Medium | High | High |
| LVAZ | High | Medium | Low |
| LVB0 | High | Medium | Low |
| LVB1 | Low | High | High |
| LVRX | Medium | Low | Low |
| LWEN | Medium | Medium | Low |
| LWEO | Medium | High | Low |
| LWEP | Medium | Medium | Low |
| LWEQ | Medium | Medium | Medium |
| LWQY | High | Medium | Medium |
| LWQZ | Medium | Medium | Medium |
| LYMC | Medium | Medium | Low |
| LYMD | Low | High | Low |
| LYMG | Medium | Medium | Medium |
| LYMP | Medium | Medium | Medium |
| LYON | Medium | High | High |
| LZ6I | Medium | Medium | Low |
| LMTU | High | Medium | Medium |
| LUS0 | Low | Medium | High |
| LV6W | Medium | Medium | Medium |
| LV6Z | High | Medium | Medium |
| LV71 | Medium | High | High |
| LV73 | Medium | Medium | High |
| LV74 | High | Medium | Medium |
| LV92 | High | Medium | High |
| LVAZ | High | Medium | Low |
| LVB0 | High | Medium | Low |
| LVB1 | Low | High | High |
| LVRX | Medium | Low | Low |
| LVZ2 | Low | Medium | Low |
| LWEN | Medium | Medium | Low |
| LWEO | Medium | High | Low |
| LWEP | Medium | Medium | Low |
| LWEQ | Medium | Medium | Medium |
| LWQY | High | Medium | Medium |
| LWQZ | Medium | Medium | Medium |
| LXO2 | High | Medium | Medium |
| LXVP | High | Medium | Medium |
| LXVX | Medium | Medium | Low |
| LY15 | High | Medium | High |
| LYMC | Medium | Medium | Low |
| LYMD | Low | High | Low |
| LYOM | Medium | Medium | Low |
| LYON | Medium | High | High |
| LYOP | Medium | Medium | Medium |
| LYOQ | High | High | High |
| LYOR | Medium | Medium | Medium |
| LYOT | Medium | High | High |
| LYOU | Medium | Medium | Low |
| LYOV | Medium | Medium | High |
| LYOV | Medium | Medium | High |
| LYOW | Medium | Medium | Low |
| LZIM | Medium | Medium | Low |
| M1T5 | High | High | Low |
| LV6Z | High | Medium | Medium |
| LVRX | Medium | Low | Low |
| LYMC | Medium | Medium | Low |
| LYON | Medium | High | High |
| LZ6I | Medium | Medium | Low |
| LV92 | High | Medium | High |
| LWQY | High | Medium | Medium |
| LWQZ | Medium | Medium | Medium |
| M4IP | High | Medium | Medium |
| M4RW | High | Medium | Low |
| LYMC | Medium | Medium | Low |
| LYON | Medium | High | High |
| LYOU | Medium | Medium | Low |
| LYOW | Medium | Medium | Low |
| M1T5 | High | High | Low |
| M4IM | Medium | Medium | Medium |
| M4RX | High | Medium | Medium |
| M4SY | High | Medium | Low |
| M4TF | High | Medium | Low |
| M4TG | Medium | Medium | Low |
| M4TI | High | Medium | Low |
| M4TJ | High | Medium | Low |
| M4WO | High | Medium | Low |
| M52J | High | Medium | Low |
| M59R | Medium | Medium | Medium |
| M5KD | High | Medium | Medium |
| M5LR | Medium | Medium | Low |
| M6AO | Medium | Medium | Medium |
| M6JU | Low | Medium | Medium |
| M6JW | Medium | Medium | Low |

Composite materials are described herein. An example composite material may comprise a shell fiber layer. The shell fiber layer may comprise one or more of nylon, polyester, or elastane. The shell fiber layer may consist essentially of one or more of nylon, polyester, or elastane. The shell fiber layer may comprise about 100 weight percent (wt %) polyester from a total of 100 wt % of the shell fiber layer. The shell fiber layer may comprise greater than 90 wt % polyester from a total of 100 wt %. The shell fiber layer may comprise about 90 wt %, 91 wt %, 92 wt %, 93 wt %, 94 wt %, 95 wt %, 96 wt %, 97 wt %, 98 wt %, 99 wt %. Other loadings may be used. The shell fiber layer may comprise about 58 wt % nylon, about 37 wt % polyester, and about 5 wt % elastane. The shell fiber layer may comprise about 93 wt % nylon and about 7 wt % elastane. The shell fiber layer may comprise between 50 wt % and 100 wt % nylon. The shell fiber layer may comprise nylon by weight percent wt % as 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt % based on 100 wt % of the composite material. Other loadings may be used. The shell fiber layer may comprise about 62 wt % nylon, about 33 wt % polyester, and about 5 wt % elastane. The shell fiber layer may comprise about 93 wt % nylon and about 7 wt % elastane. The shell fiber layer may comprise about 75 wt % polyester and about 25 wt % nylon. The shell fiber layer may comprise 96% nylon, 4% elastane.

The example composite material may comprise a membrane disposed adjacent the shell fiber layer. The membrane may be coupled to the shell fiber layer. The membrane may be glued to the shell fiber layer.

Composite materials are described herein. An example composite material may comprise a shell fiber layer. The example composite material may comprise a membrane disposed adjacent the shell fiber layer. The example composite material may exhibit a low range hydrostatic water resistance of above 5000 millimeter (mm) as measured using American Association of Textile Chemists and Colorists (AATCC) 127. The example composite material may exhibit an air permeability of above 0.25 as measured using American Society for Testing and Materials (ASTM) D737. The example composite material may exhibit a moisture vapor transmission rate (MVTR) of above 30 kilogram per square meter per 24 hour (kg/sqm/24 hr) as measured using Japanese Industry Standards (JIS) L1099-B1.

The example composite material may exhibit a low range hydrostatic water resistance of between 5000 millimeter (mm) and 25,000 mm as measured using American Association of Textile Chemists and Colorists (AATCC) 127. The example composite material may exhibit an air permeability of between 0.25 and 1 cubic feet per minute (cfm) as measured using American Society for Testing and Materials (ASTM) D737. The example composite material may exhibit a moisture vapor transmission rate (MVTR) of between 30 kilogram per square meter per 24 hour (kg/sqm/24 hr) and 55 Kg/sqm/24 hr as measured using Japanese Industry Standards (JIS) L1099-B1.

A fabric weight associated with the example composite material may be between 90 grams per square meter (gsm) and 200 gsm. A fabric weight associated with the example composite material may be between 90 gsm and 180 gsm. A fabric weight associated with the example composite material may be between 91 gsm and 177 gsm. Other fabric weights and component weights may be used.

The example composite material may exhibit a low range hydrostatic water resistance of between 5000 millimeter (mm) and 25,000 mm as measured using American Association of Textile Chemists and Colorists (AATCC) 127. The example composite material may exhibit an air permeability of between 0.75 and 1 cubic feet per minute (cfm) as measured using American Society for Testing and Materials (ASTM) D737.

A fabric weight associated with the example composite material may be between 90 grams per square meter (gsm) and 200 gsm. A fabric weight associated with the example composite material may be between 90 gsm and 180 gsm. A fabric weight associated with the example composite material may be between 91 gsm and 177 gsm.

Articles are described herein. An example article may comprise composite material described herein. The example article may comprise a garment, gloves, footwear, headwear, bib pants, pants, a jacket, a tent, a sleeping bag, and a backpack.

1. A composite material comprising:
a shell fiber layer comprising between 58 wt % and 72 wt % nylon and between 28 wt % and 37 wt % polyester without exceeding 100 wt %; and
a breathable electrospun fiber membrane disposed adjacent the shell fiber layer,
wherein the composite material exhibits a low range hydrostatic water resistance of at least 5,000 millimeter (mm) as measured using American Association of Textile Chemists and Colorists (AATCC) 127;
wherein the composite material exhibits an air permeability of at least 0.25 cubic feet per minute (cfm) as measured using American Society for Testing and Materials (ASTM) D737; and
wherein the composite material exhibits a moisture vapor transmission rate (MVTR) of at least 30 kilogram per square meter per 24 hour (kg/sqm/24 hr) as measured using Japanese Industry Standards (JIS) L1099-B1.

2. The composite material of claim 1, wherein the shell fiber layer comprises 58 wt % nylon and 37 wt % polyester.

3. The composite material of claim 1, wherein the shell fiber layer comprises 62 wt % nylon and 33 wt % polyester.

4. The composite material of claim 1, wherein the shell fiber layer comprises 72 wt % nylon and 28 wt % polyester.

5. The composite material of claim 1, wherein an overall composite fabric weight associated with the composite material is between 102 gsm and 136 gsm.

6. The composite material of claim 1, wherein the membrane is coupled to the shell fiber layer.

7. The composite material of claim 1, wherein the membrane is glued to the shell fiber layer.

8. An article comprising the composite material of claim 1, wherein the article comprises a garment, gloves, footwear, headwear, bib pants, pants, a jacket, a tent, a sleeping bag, and a backpack.

9. A composite material comprising:
a shell fiber layer comprising between 23 wt % and 31 wt % nylon and between 69 wt % and 77 wt % polyester without exceeding 100 wt %; and
a breathable electrospun fiber membrane disposed adjacent the shell fiber layer,
wherein the composite material exhibits a low range hydrostatic water resistance of at least 5,000 millimeter (mm) as measured using American Association of Textile Chemists and Colorists (AATCC) 127;
wherein the composite material exhibits an air permeability of at least 0.25 cubic feet per minute (cfm) as measured using American Society for Testing and Materials (ASTM) D737; and
wherein the composite material exhibits a moisture vapor transmission rate (MVTR) of at least 30 kilogram per square meter per 24 hour (kg/sqm/24 hr) as measured using Japanese Industry Standards (JIS) L1099-B1.

10. The composite material of claim 7, wherein the shell fiber layer comprises 25 wt % nylon and 75 wt % polyester.

11. The composite material of claim 7, wherein the shell fiber layer comprises 23 wt % nylon and 77 wt % polyester.

12. The composite material of claim 7, wherein the shell fiber layer comprises 31 wt % nylon and 69 wt % polyester.

13. The composite material of claim 1, wherein an overall composite fabric weight associated with the composite material is between 102 gsm and 165 gsm.

14. The composite material of claim 7, wherein the membrane is coupled to the shell fiber layer.

15. The composite material of claim 7, wherein the membrane is glued to the shell fiber layer.

16. An article comprising the composite material of claim 9, wherein the article comprises a garment, gloves, footwear, headwear, bib pants, pants, a jacket, a tent, a sleeping bag, and a backpack.
